(19) United States
(12) Patent Application Publication
(10) Pub. No.: US 2007/0001528 A1
(43) Pub. Date: Jan. 4, 2007

(54) Brushless motor

(76) Inventors: Fuhito Umegaki, Osato-gun (JP); Osamu Takahashi, Osato-gun (JP)

Correspondence Address: WENDEROTH, LIND & PONACK, L.L.P., 2033 K STREET N. W., SUITE 800, WASHINGTON, DC, 20006-1021, US

(21) Appl. No.: 11/517,332

(22) Filed: Sep. 8, 2006

Related U.S. Application Data
(63) Continuation of application No. PCT/JP05/04075, filed on Mar. 9, 2005.

(30) Foreign Application Priority Data
Mar. 11, 2004 (JP) 2004-069689

(51) Int. Cl. H02K 7/00; H02K 11/00; H02K 5/10

(52) U.S. Cl. 310/88; 310/71; 310/67 R; 417/423.14

(57) ABSTRACT

The present invention realizes improved workability of electrical connection between an exciting coil and a circuit board disposed in a casing and ensures waterproofing of a connection portion. A waterproof case 25 in which a terminal bar 24 is buried is composed of a large-diameter portion 25a in a hollow bottomed-cylindrical shape and a small-diameter portion 25b around whose outer peripheral surface an O-ring 27 is fitted. A U-shaped end of the terminal bar 24 connected to an end of an exciting coil 7 is positioned in the hollow portion of the large-diameter portion 25a, part of a substantially linear portion extending from the U-shaped end of the terminal bar 24 is buried in the small-diameter portion 25b in an axial direction, and the other portion of the terminal bar 24 protrudes from the small-diameter portion 25b. An end of the other portion is soldered to a circuit board 4, and the small-diameter portion 25a of the waterproof case 25 is fittingly inserted in a cylindrical fitting portion 26 formed in the casing 1, whereby water-tightness is ensured.

### BACKGROUND OF THE INVENTION

1. Field of the Invention

The present invention relates to a brushless motor, more particularly, to a brushless motor that realizes improved workability of a connection part between an exciting coil wound around a stator and a circuit board disposed inside a casing, improved waterproofing in the connection part, and so on.

2. Description of the Related Art

Conventionally, as a brushless motor of this type, there has been generally known, for example, a brushless motor in which, on an upper surface of a casing housing a circuit board, a rotor is rotatably supported and a stator having an exciting coil wound therearound is fixed (see, for example, Patent document 1).
Patent document 1: Japanese Patent Application Laid-open No. 2001-69741

In such a brushless motor, the exciting coil and an electric circuit on the circuit board need to be electrically connected. In the above-described conventional example, the electrical connection between the exciting coil wound around the stator and the circuit board is realized in such a manner that one end of a linear, stiff conductor as a terminal pin is soldered to the exciting coil and the other end is joined to a relatively wide conductive member called a busbar provided on the circuit board.

In the brushless motor as described above, the terminal pin is provided to penetrate the casing, and considering that the brushless motor is sometimes used for a vehicle blower or the like, a measure has to be taken to fully ensure waterproofing of this penetration portion. Further, in the above-described conventional example, the soldering of the exciting coil and the terminal pin is performed along with the waterproofing process of the exciting coil. From the viewpoint of providing a low-price brushless motor, there is a demand for higher workability of a portion requiring such a water proofing process.

### SUMMARY OF THE INVENTION

The present invention was made in view of the above circumstances, and an object thereof is to provide a brushless motor that realizes improved workability of electrical connection between an exciting coil wound around a stator and a circuit board disposed in a casing and reliably ensures waterproofing with a simple structure.

A brushless motor according to an embodiment of the present invention includes: a casing that houses and holds a circuit board and supports a rotor in a rotatable manner,
wherein a stator around which an exciting coil is wound is disposed inside the rotor, and the exciting coil is connected to the circuit board via a terminal bar provided in the casing, the brushless motor further comprising
a waterproof case having a portion in a hollow form, and
wherein one end of the terminal bar connected to the exciting coil is positioned in the portion in the hollow form of the waterproof case, while the other end of the terminal bar protrudes from the waterproof case, and an adhesive is filled in a hollow portion of the portion in the hollow form so as to bury the terminal bar, and
wherein the waterproof case is disposed on an upper surface side of the casing, with the portion in the hollow form facing the rotor.

### BRIEF DESCRIPTION OF THE DRAWINGS

FIG. 1 is a vertical cross-sectional view showing a first structure example of a brushless motor of an embodiment of the present invention;

FIG. 2 is a plane view of the brushless motor shown in FIG. 1 before a blower is attached thereto;

FIG. 3 is a side view of the brushless motor shown in FIG. 1 before the blower is attached thereto;

FIG. 4 is a bottom view of the brushless motor shown in FIG. 1;

FIG. 5 is an exploded vertical cross-sectional view showing an essential part to explain the assembly procedure of a casing;

FIG. 6 is an enlarged vertical cross-sectional view of the vicinity of a waterproof case in the first structure example shown in FIG. 1;

FIG. 7 is an enlarged vertical cross-sectional view of the vicinity of a waterproof case in a second structure example;

FIG. 8 is an enlarged vertical cross-sectional view of the vicinity of a waterproof case in a third structure example; and

FIG. 9 is an enlarged vertical cross-sectional view of the vicinity of a waterproof case in a fourth structure example.

### DETAILED DESCRIPTION OF THE PREFERRED EMBODIMENTS

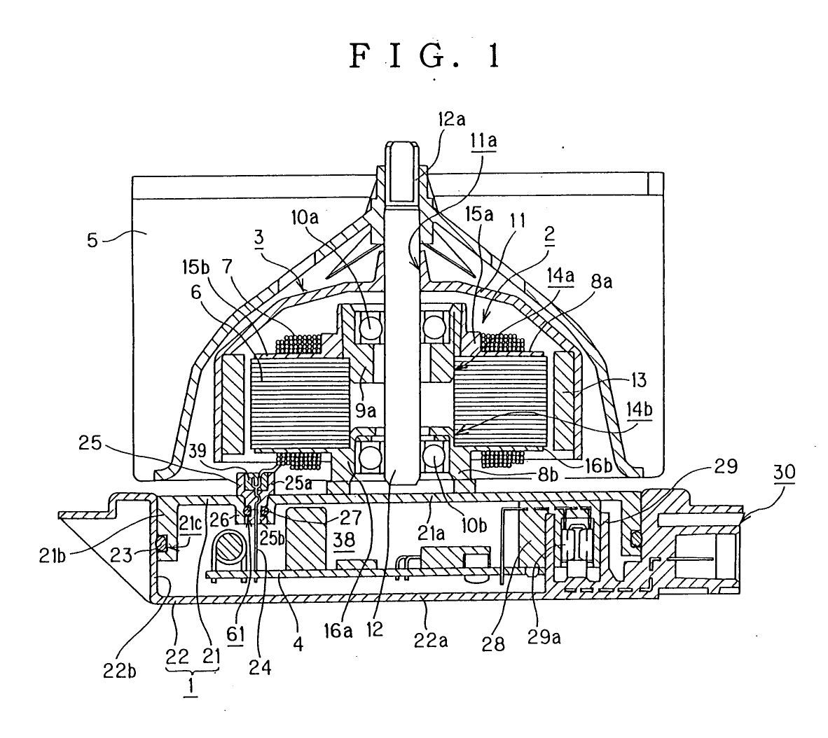

Hereinafter, an embodiment of the present invention will be described with reference to FIG. 1 to FIG. 9.

It should be noted that members, dispositions, and so on described below are not intended to restrict the present invention, and various modifications can be made without departing from the spirit of the present invention.

First, a first structure example of a brushless motor of the embodiment of the present invention will be described with reference to FIG. 1 to FIG. 6.

The brushless motor of the embodiment of the present invention is mainly composed of a stator 2 whose base portion is fixed to a casing 1, a rotor 3 rotatably provided on the stator 2, and a circuit board 4 controlling current supply to an exciting coil 7 wound around the stator 2 (see FIG. 1). The brushless motor having such a structure is used for rotary-driving, for example, a blower 5 in a vehicle air-conditioner, and the blower 5 is fixed to a tip 12a of a rotary shaft 12 (see FIG. 1).

The stator 2 in the embodiment of the present invention has a laminated core 6, the exciting coil 7 wound around the laminated core 6, an upper insulation cover 8a, and a lower insulation cover/bearing holder 8b, and is disposed inside the rotor 3.

The upper insulation cover 8a has: a portion 15a in a hollow cylindrical shape; and a ring-shaped flange 15b provided at an appropriate position on an outer peripheral surface of the portion 15a. An upper bearing holder 9a is press-fitted in the portion 15a in the hollow cylindrical shape. The upper bearing holder 9a holds an upper bearing 10a and has an upper press-fitted portion 14a in a columnar shape press-fitted to an upper portion (a rotor 3 side in FIG. 1) of the laminated core 6.

The lower insulation cover/bearing holder 8b is disposed on a lower side (a casing 1 side in FIG. 1) of the laminated core 6 to function as an insulation cover similarly to the aforesaid upper insulation cover 8a, and also houses/holds a lower bearing 10b. Specifically, similarly to the aforesaid upper insulation cover 8a, the lower insulation cover/bearing holder 8b has: a portion 16a in a substantially hollow cylindrical shape in which the lower bearing 10b is disposed; and a ring-shaped flange 16b formed at an appropriate position on an outer peripheral surface of the portion 16a. Further, at an end of the portion 16a on an opposite side of the casing 1, a lower press-fitted portion 14b press-fitted in a lower portion of the laminated core 6 is provided.

In the laminated core 6, the upper press-fitted portion 14a of the upper bearing holder 9a is press-fitted in the upper center portion thereof and the lower press-fitted portion 14b of the lower insulation cover/bearing holder 8b is press-fitted to the lower center portion thereof, so that the laminated core 6 is sandwiched and supported by the upper insulation cover 8a and the upper bearing holder 9a and the lower insulation cover/bearing holder 8b from above and under (see FIG. 1).

In the lower insulation cover/bearing holder 8b, an end portion opposite the end portion where the lower press-fitted portion 14b is formed is fixed to the motor cover 21 being a first case member constituting the casing 1. Center portions of the upper bearing holder 9a and the lower insulation cover/bearing holder 8b are hollow, and the rotary shaft 12 is inserted through the hollow portions, so that the rotary shaft 12 is rotatably supported on the casing 1 by the upper bearing 10a and the lower bearing 10b (see FIG. 1).

The rotor 3 has a yoke 11 substantially in a bowl shape. An open surface of the yoke 11 is positioned on a casing 1 side and a closed surface thereof forms an upper surface. The rotary shaft 12 is inserted through a through hole 11a formed in a center portion of the closed surface, so that the rotor 3 is fixed to the shaft 12 and held on the casing 1.

On an inner peripheral surface of the yoke 11, a plurality of magnets 13 are fixedly arranged in a circumferential direction at appropriate intervals and face a peripheral surface of the laminated core 6 via an appropriate interval (see FIG. 1).

A casing 1 is composed of a motor cover 21 and a board cover 22, and in particular, unlike a conventional casing, the casing 1 in the embodiment of the present invention does not have a through hole or the like for ventilation between the inside and the outside, and thus is formed as a hermetic vessel.

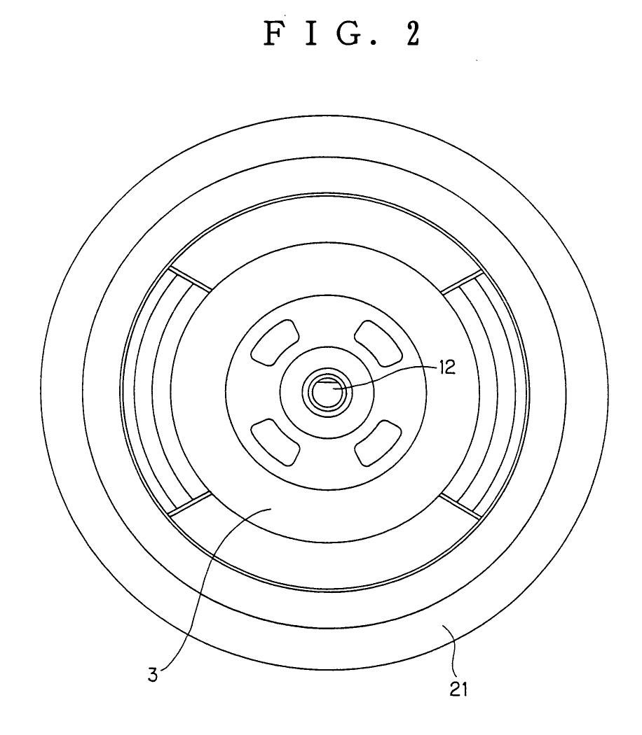

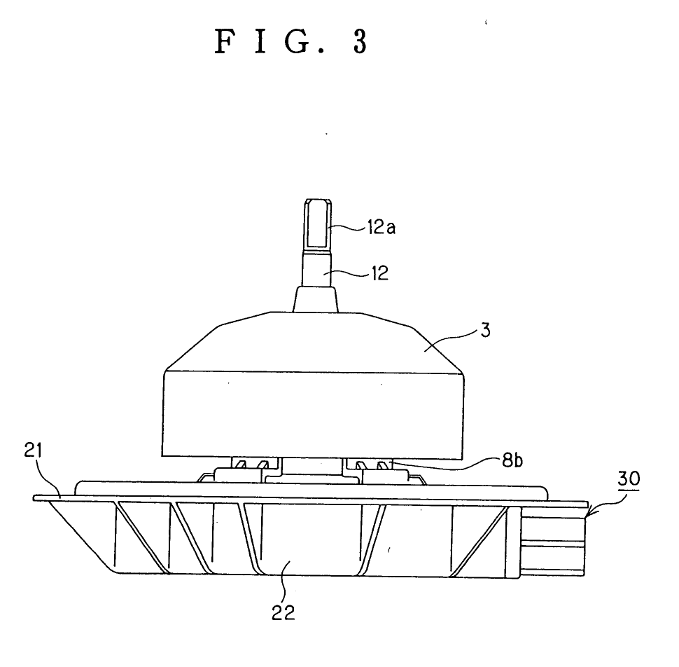

The motor cover 21 as a first case member is made of, for example, an aluminum member, and in a plane view, an outer appearance of the whole motor cover 21 is in a substantially disk shape (see FIG. 2). The motor cover 21 has a first ring-shaped peripheral wall 21b provided upright on a peripheral edge of a motor cover base portion 21a in a substantially disk shape (see FIG. 1). On an upper surface side of the motor cover 21, the rotor 3 is rotatably supported as described above (see FIG. 1 and FIG. 3).

In an appropriate position of an outer peripheral surface of the first ring-shaped peripheral wall 21b, a ring-shaped groove 21c is formed in a recessed manner, and an O-ring 23 is fitted in the ring-shaped groove 21c, so that the O-ring 23 is fitted around the first ring-shaped peripheral wall 21b.

Further, a not-shown portion of a circuit board 4 is screw-fixed to a rear surface side of the motor cover 21, that is, a side opposite the side on which the rotor 3 is rotatably supported.

A circuit board 4 is supplied with power and driving signals from an external part via a board-side connector 28 attached to the circuit board 4, a later-described cover-side connector 29 provided on the board cover 22, and an external connector connection part 30, thereby constituting an electronic circuit for controlling current supply to an exciting coil 7.

The board-side connector 28 is attached to the vicinity of an edge of the circuit board 4, with part thereof protruding from the circuit board 4 (see FIG. 1 and FIG. 5), and is fitted to the later-described cover-side connector 29 of the board cover 22.

The circuit board 4 and the exciting coil 7 are electrically connected to each other via a terminal bar 24 made of a conductive member. Specifically, in the embodiment of the present invention, one end of the terminal bar 24 is formed in a substantially U-shape so as to enable connection to the exciting coil 7, and a portion right under the U-shaped end is buried in a waterproof case 25 (see FIG. 1).

The waterproof case 25 in the embodiment of the present invention is in a substantially columnar shape as a whole and is composed of a large-diameter portion 25a and a small-diameter portion 25b. The large-diameter portion 25a is in a hollow bottomed-cylindrical shape. The U-shaped end of the terminal bar 24 is positioned in the large-diameter portion 25a, a substantially linear portion extending from the U-shaped end of the terminal bar 24 is partly buried in an axial direction in the small-diameter portion 25b, and the other portion of the terminal bar 24 protrudes from the small-diameter portion 25b (see FIG. 1).

At an appropriate position of the motor cover base portion 21a of the motor cover 21, a hollow cylindrical fitting portion 26 is formed to protrude toward a rear surface side of the motor cover 21, and the small-diameter portion 25b of the waterproof case 25 is inserted in the cylindrical fitting portion 26. In an outer peripheral surface of the small-diameter portion 25b, a waterproof case ring-shaped groove 61 is formed in a recessed manner, and an O-ring 27 is fitted in the waterproof case ring-shaped groove 61.

In a state where the waterproof case 25 is inserted in a cylindrical fitting portion 26, an end of the exciting coil 7 is welded or soldered to the U-shaped end of the terminal bar 24, thereafter, the hollow portion of the large-diameter portion 25a is filled with an adhesive 39, and the other end of the terminal bar 24 is soldered to the circuit board 4 (see FIG. 1).

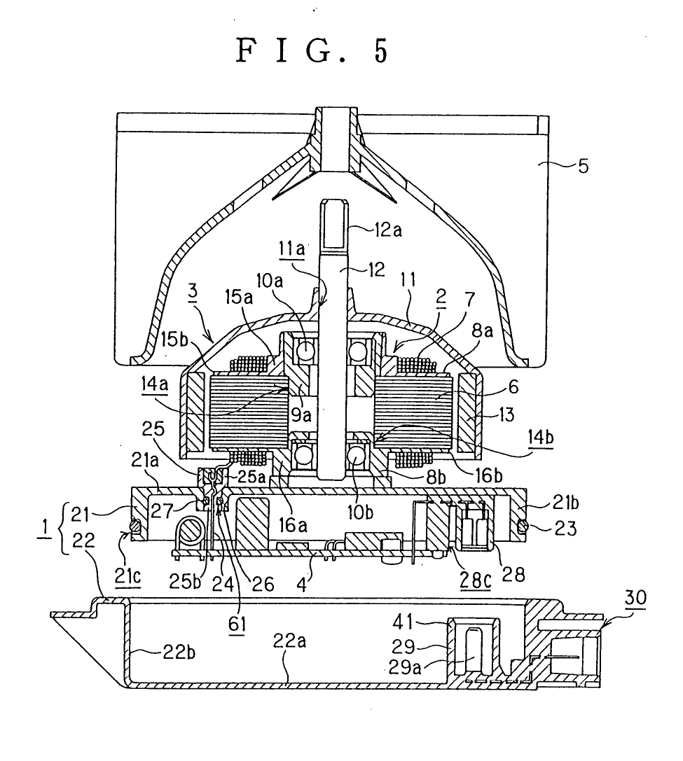

Here, the end of the terminal bar 24 and the end of the exciting coil 7 are welded or soldered in a state where the terminal bar 24 is buried in the waterproof case 25 as described above, in other words, in a state where the U-shaped end of the terminal bar 24 is positioned inside the large-diameter portion 25a. Therefore, a size of an opening of the large-diameter portion 25a, specifically, in this structure example, an inside diameter R (see FIG. 6) is set large enough to allow a tip of a welding electrode or a soldering tool to enter the inside of the large-diameter portion 25a so that a welding or soldering work between the end of the terminal bar 24 and the end of the exciting coil 7 can be performed.

Incidentally, insert molding is not restrictive as a method of disposing the terminal bar 24 in the smaller-diameter portion 25b of the waterproof case 25, but before or after being welded or soldered to the exciting coil 7, the terminal bar 24 may be inserted as a separate component in the smaller-diameter portion 25b and thereafter fixed to the waterproof case 25 by filling an adhesive in the large-diameter portion 25a.

Another possible structure to ensure water-tightness between the cylindrical fitting portion 26 and the small-diameter portion 25b is to apply a waterproof adhesive therebetween, instead of attaching an O-ring 27 around the small-diameter portion 25b.

Further, the end of the exciting coil 7 to be welded or soldered to the terminal bar 24 is led in from an upper side of the waterproof case 25, that is, the opening side of the large-diameter portion 25a (see FIG. 1), but the end portion of the exciting coil 7 need not be thus led in from the upper side of the waterproof case 25, and may be led in from a side surface of the waterproof case 25, for example, a side of the large-diameter portion 25a.

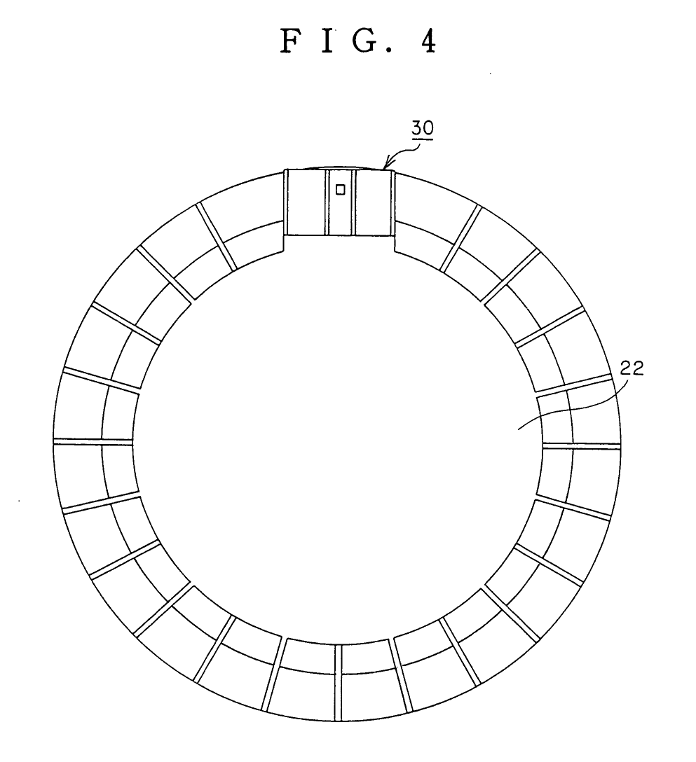

The board cover 22 as a second case member is made of, for example, a resin member, and similarly to the motor cover 21, it has a substantially disk-shaped outer appearance as a whole in a bottom view (see FIG. 1 and FIG. 4), and has a second ring-shaped peripheral wall 2b provided upright on a peripheral edge of a board cover base portion 22a (see FIG. 1). An inside diameter of the second ring-shaped peripheral wall 22b is substantially equal to an outside diameter of the aforesaid first ring-shaped peripheral wall 21b of the motor cover 21 (see FIG. 1).

Therefore, the motor cover 21 is fitted to the board cover 22, with an outer peripheral portion of the first ring-shaped peripheral wall 21b thereof being joined to an inner peripheral surface of the second ring-shaped peripheral wall 22b of the board cover 22 (see FIG. 1). Between the motor cover 21 and the board cover 22, a housing space 38 for housing and holding the aforesaid circuit board 4 is formed.

The cover-side connector 29 which is fitted to the aforesaid board-side connector 28 attached to the circuit board 4 when the motor cover 21 is fitted to the board cover 22 is integrally formed on the board cover base portion 22a of the board cover 22 in the embodiment of the present invention. The position of the cover-side connector 29 is set in advance so that the board-side connector 28 and the cover-side connector 29 are fitted to each other when the motor cover 21 is fitted to the board cover 22. A connector terminal 29a of the cover-side connector 29 is buried when the board cover 22 of the embodiment of the present invention is manufactured by resin molding, and an end of the connector terminal 29a is positioned at an external connector connection part 30 that is provided on an outer side surface of the board cover 22 by integral molding (see FIG. 1). A not-shown external connector is fitted to the external connector connection part 30, so that power supply voltage and driving pulses can be supplied to the circuit board 4 from an external part via the external connector connection part 30, the cover-side connector 29, and the board-side connector 28.

Next, the procedure for assembling the motor cover 21 and the board cover 22 in such a structure will be described with reference to FIG. 1 and FIG. 5.

First, it is assumed that the circumferential assembly positions of the motor cover 21 and the board cover 22 are determined in advance, and for example, marks are put on appropriate positions in peripheral edges thereof. Here, by aligning the pre-set assembly positions, the board-side connector 28 and the cover-side connector 29 are directly fitted to each other when the motor cover 21 and the board cover 22 are fitted to each other.

It is also premised that the stator 2, the rotor 3, and so on have been attached on the motor cover 21, and the circuit board 4, which is connected to the exciting coil 7 via the terminal bar 24, has been attached to the motor cover 21, and further, an O-ring 23 has been fitted around the motor cover 21.

Under such premises, the predetermined positions of the motor cover 21 and the board cover 22 are aligned with each other so that they are in a proper circumferential relative position, and subsequently, the first ring-shaped peripheral wall 21b of the motor cover 21 is gradually pushed into the board cover 22. In accordance with the insertion of the motor cover 21 into the board cover 22, the board-side connector 28 and the cover-side connector 29 start to be fitted to each other, and when a top of the peripheral wall 41 of the cover-side connector 29 abuts on a bottom of a insertion groove 28c of the board-side connector 28, the fitting of the motor cover 21 and the board cover 22 and the fitting of the board-side connector 28 and the cover-side connector 29 are completed (see FIG. 1 and FIG. 5).

Then, by fitting the not-shown external connector to the external connector connection part 30, it is possible to supply power supply voltage and driving signals from the external part.

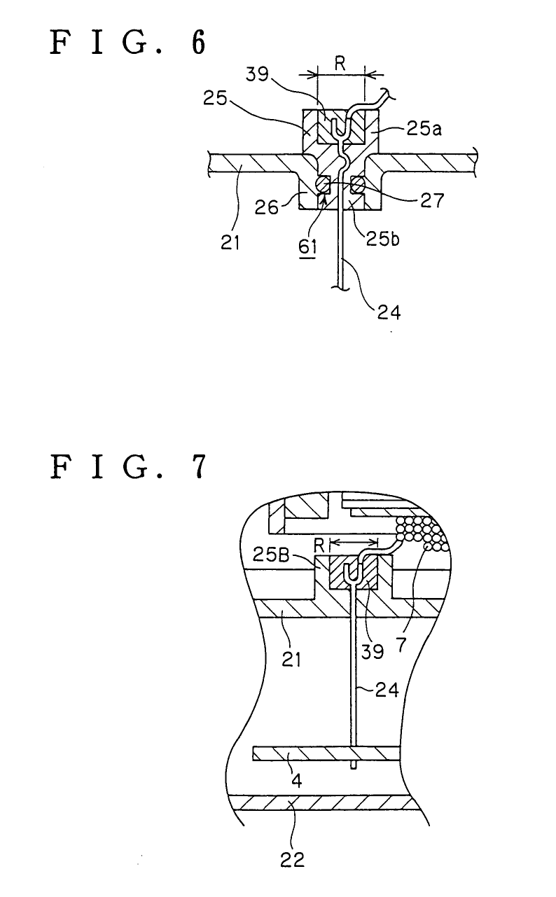

Next, a second structure example will be described with reference to FIG. 7. The same reference numerals and symbols are used to designate the same components as those in the first structure example shown in FIG. 1 to FIG. 6, and detailed description thereof will be omitted. The following description will focus on what are different.

The second structure example is different from the first structure example described above in that a waterproof case 25B is formed integrally on the motor cover 21.

Specifically, the waterproof case 25B is in a hollow bottomed-cylindrical shape, and is disposed on the motor cover 21 by integral molding with its open side positioned on an upper surface side of the motor cover 21, that is, on a side where the rotor 3 is positioned.

As in the above-described first structure example, the U-shaped end of the terminal bar 24 is positioned in the hollow portion of the waterproof case 25B, a substantially linear portion extending from the U-shaped end passes through a bottom of the waterproof case 25B, that is, the motor cover 21, and the other end reaches the circuit board 4 to be soldered to the circuit board 4. An end of the exciting coil 7 is connected to the U-shaped end of the terminal bar 24 (see FIG. 7).

As in the first structure example described above, a size of an open portion of the waterproof case 25B, that is, an inside diameter R, has to be set large enough to allow a tip of a welding electrode or a soldering tool to enter the waterproof case 25B so that a welding or soldering work of the end of the terminal bar 24 and the end of the exciting coil 7 can be performed.

As in the first structure example, the end of the exciting coil 7 may be led in from a side of the waterproof case 25B.

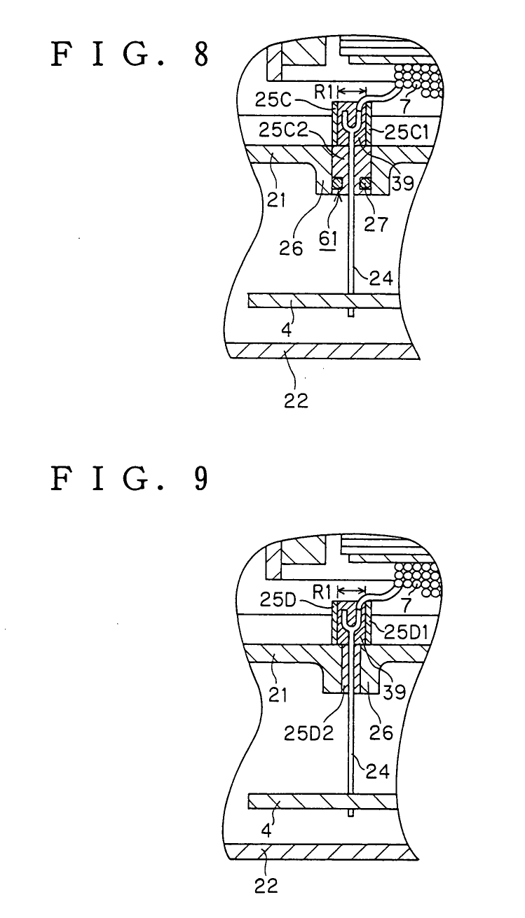

Next, a third structure example will be described with reference to FIG. 8. The same reference numerals and symbols are used to designate the same components as those in the first structure example shown in FIG. 1 to FIG. 6, and detailed description thereof will be omitted. The description below will focus on what are different.

A waterproof case 25C in the third structure example is different from that in the first structure example described above in that an open portion the waterproof case 25C where the U-shaped end of the terminal bar 24 is positioned may have a relatively small size, and in addition, the waterproof case 25C is composed of two members. The other structure is basically the same as that of the above-described first structure example.

Specifically, the waterproof case 25C is composed of a first waterproof case member 25C1 and a second waterproof case member 25C2. The first waterproof case member 25C1 is formed in a hollow cylindrical shape and the second waterproof case member 25C2 has basically the same structure as that of the small-diameter portion 25b of the waterproof case 25 in the above-described first structure example. In the embodiment of the present invention, the first and second waterproof case members 25C1, 25C2 have a columnar outer appearance and outside diameters thereof are set equal to each other (see FIG. 8).

In the case of the waterproof case 25C, it is premised that the terminal bar 24 is attached in the waterproof case 25C after the terminal bar 24 and the exciting coil 7 are welded or soldered, and therefore, the open portion of the first waterproof case member 25C1 need not have a size large enough to allow a tip of a welding electrode or a soldering tool to enter as described in the first structure example. That is, it suffices that an inside diameter R1 of the first waterproof case member 25C1 is smaller than the inside diameter R shown in FIG. 6 described above.

How the terminal bar 24 is attached in the waterproof case 25C in such a structure will be described. First, predetermined portions of the terminal bar 24 and the exciting coil 7 are welded or soldered.

The second waterproof case member 25C2 by itself is fitted to the cylindrical fitting portion 26 of the motor cover 21 in advance, with the O-ring 27 being positioned on an inner side of the casing 1 as shown in FIG. 8.

Next, the first waterproof case member 25C1 is positioned on an upper side of the second waterproof case member 25C2 (see FIG. 8), and an end of the terminal bar 24 opposite the U-shaped end is inserted into the first waterproof case member 25C1 and then to the second waterproof case member 25C2, so that the U-shaped end of the terminal bar 24 is positioned in the first waterproof case member 25C1 and the other end is positioned at a predetermined portion where it can be soldered to the circuit board 4, as shown in FIG. 8.

Then, an adhesive 39 is filled in the first waterproof case member 25C1, whereby the mutual fixing of the first and second waterproof case members 25C1, 25C2 and the attachment of the terminal bar 24 in the waterproof case 25C are completed.

It should be noted that the end of the exciting coil 7 may be led in from a side of the first waterproof case member 25C1 as described in the first structural example.

Next, a fourth structure example will be described with reference to FIG. 9. The same reference numerals and symbols are used to designate the same components as those in the first and third structure examples shown in FIG. 1 to FIG. 6 and FIG. 8, and detailed description thereof will be omitted. The description below will focus on what are different.

A waterproof case 25D in the fourth structure example does not have the O-ring 27 of the second waterproof case member 25C2 constituting the waterproof case 25C in the above-described third structure example.

Specifically, the waterproof case 25D is composed of a first waterproof case member 25D1 and a second waterproof case member 25D2, and the second waterproof case member 25D2 is the same as the second waterproof case member 25C2 in the third structure example in that the second waterproof case member 25D2 is formed so as to allow the terminal bar 24 to pass through the vicinity of the center of a cylindrical member. However, an outer peripheral surface of the second waterproof case member 25D2, unlike that of the second waterproof case member 25C2 in the third structure example, is not structured to allow an O-ring to be fitted therearound but is a cylinder surface (see FIG. 9).

The procedure for attaching the terminal bar 24 in the waterproof case 25D in such a structure is basically the same as that described in the above third structure example, and therefore, detailed description thereof will not be repeated here.

According to the preset invention, the terminal bar used for electrically connecting the exciting coil and the circuit board is buried in the waterproof case having the portion in the hollow form, the waterproof case is fitted in the casing of the brushless motor or is disposed on the casing by integral molding, and the adhesive is filled in the hollow portion. This brings about an effect that, with a relatively simple structure, an insulating process of the connection portion between the exciting coil and the terminal bar can be facilitated and water-tightness of a portion of the terminal bar passing through the casing is reliably ensured.

What is claimed is:

1. A brushless motor comprising a casing that houses and holds a circuit board and supports a rotor in a rotatable manner,
wherein a stator around which an exciting coil is wound is disposed inside the rotor, and the exciting coil is connected to the circuit board via a terminal bar provided in the casing, the brushless motor further comprising
a waterproof case having a portion in a hollow form, and
wherein one end of the terminal bar connected to the exciting coil is positioned in the portion in the hollow form of said waterproof case, while the other end of the terminal bar protrudes from said waterproof case, and an adhesive is filled in a hollow portion of the portion in the hollow form so as to bury the terminal bar, and
wherein said waterproof case is disposed on an upper surface side of said casing, with the portion in the hollow form facing the rotor.

2. The brushless motor according to claim 1,
wherein said waterproof case has a substantially cylindrical outer shape as a whole, and is composed of a first portion in a hollow form and a second portion which extends from the first portion and in which a portion extending from the end of the terminal bar connected to the exciting coil is buried by insert molding, and
wherein said casing has a cylindrical portion which protrudes toward an inner side of the casing and in which the second portion of the waterproof case is fittingly inserted.

3. The brushless motor according to claim 2,
wherein an O-ring is fitted around an outer peripheral surface of the second portion.

4. The brushless motor according to claim 1,
wherein said waterproof case has a substantially columnar outer shape as a whole, and is composed of a first waterproof case member in a hollow form and a second waterproof case member in a substantially columnar shape which allows the terminal bar to pass through a center portion thereof in an axial direction, and
wherein said casing has a cylindrical portion which protrudes toward an inner side of said casing and in which the second waterproof case member is fittingly inserted, the first waterproof case member is placed on the second waterproof case member in a state where the second waterproof case member is fitted in the cylindrical portion, and the first and second waterproof case members are integrally fixed by an adhesive filled in the hollow portion.

5. The brushless motor according to claim 4,
wherein an O-ring is fitted around an outer peripheral surface of the second waterproof case member.

6. The brushless motor according to claim 1,
wherein said waterproof case is in a hollow cylindrical shape and a bottom side of said waterproof case is formed integrally on the casing.
